(19) United States
(12) Patent Application Publication
(10) Pub. No.: US 2005/0061619 A1
(43) Pub. Date: Mar. 24, 2005

(54) Foreign bottle detection device

(76) Inventor: Thomas Scott Rutledge, Sarnia (CA)

Correspondence Address: James W. Kerr;Labatt Brewing Company Limited, 303 Richmond Streeet, London, ON, N6B 2H8, CA

(21) Appl. No.: 10/943,890

(22) Filed: Sep. 20, 2004

(30) Foreign Application Priority Data
Sep. 19, 2003 (CA) 2,441,687

(51) Int. Cl. B65G 47/26

(52) U.S. Cl. 198/439; 198/456

(57) ABSTRACT

The present invention provides a very simple and inexpensive device and system for mechanically detecting and, optionally ejecting non-standard bottles and other articles from a line composed of standard and non-standard bottles traveling on a conveyor. The device can be quickly adjusted as required to detect bottles based on various physical differences between the types of bottles such as diameter, buffer zones, neck diameters, shoulder heights, etc. The device is inexpensive, requires little space or maintenance and can be adapted to handle many types of non-standard bottles. It can also be used to sort articles based on those physical differences.

### FIELD OF THE INVENTION

The present invention relates to the handling of articles, such as beverage containers moving at high speed in modern production facilities. Of special interest is the use of the invention in the food and beverage industry and in particular the handling of bottles containing alcoholic and non-alcoholic beverages. Examples of such beverages include beer and beer-based drink such as shandies; coolers and low or non-alcoholic beers; non-alcoholic soft drinks such as colas; water; fruit juices and the like.

### BACKGROUND OF THE INVENTION

Beverage industries are major users of bottles and the beverage industry in many countries utilize returnable and re-usable bottles for both cost and environmental protection reasons. Such systems require return of bottles and these are collected into a “float” from which users draw when needs arise. In some countries, for greater efficiencies, the major brewers have a “common” or “standard” bottle. Not only does the bottle have a set internal volume, it has the same design and external dimensions. This should result in all bottles in the float being identical. However, many drinks, including beers, are in fact sold in bottles which, although varying from the “standard”, do not do so significantly, and hence are not so differentiable therefrom to be readily noted and removed. However, they do so sufficiently to interfere with and jam, for example, the cleaning equipment used to effect re-use of the bottles. The variances may for example be in height but especially diameter and at one or more zones along the height of the bottle, etc. Of course, some bottles are significantly different from the standard bottle and they can be readily identified and removed. In any event, all such bottles which differ from a chosen “standard” are therefore “non-standard” or “foreign” bottles, and when inadvertently included in the float are quite sufficient to cause serious, costly and continuous problems. A “standard” bottle as used herein means a bottle of a set design and dimensions chosen to be used by a number of bottlers for containing a beverage for sale at retail and which bottle is returned directly or indirectly to the beverage bottler for reuse. There are usually a number of such bottles as well as other types of bottles, such as non-returns; returns and non-reuse, etc i.e. non-standard bottles circulating in any geographical area. Consequently, unavoidably, the float of bottles created from returns although generally being made up mainly of the desired standard bottle, also includes a minority of the dimensionally different non-standard bottles. In summary the non-standard bottles in the float are not greatly different, the differences including for example a small difference in main body diameter of say up to half a centimeter; a difference in shoulder height; a “bulge” in the base region or at the label location, and similar dimensional differences.

In the beverage industry, product units such as bottles are often transported within production facilities in lines or streams in single file at high speed using conveyor systems. In some instances, the pathway defined by the conveyor is not much wider than the moving container but is sufficient to allow for free movement of the container along the conveyor. The conveyor is set up such that in many sections the containers generally travel along it in single file adjacent to one sidewall or rail of the conveyor. This generally occurs even if the width of the conveyor is greater than the width of the container. For example, empty beer bottles, very common articles to which the present invention relates, are generally required to be transported from depalletizers to a washing station, through a rinsing station to an automated filling device, often at rates of up to 1,000 or more bottles per minute. Obviously, in an operation involving so many bottles processed at those rates, there are going to be a number of bottles which are commercially unacceptable for various reasons. In addition to such returned, non-standard bottles, following being filled, a standard bottle may be under-filled, or over-filled, with beer or the bottle label may be misaligned or even totally missing. Such bottles are also not acceptable and must be separated from the acceptable bottles prior to the latter proceeding to a packaging station. There are many known systems for inspecting the stream of bottles and detecting any such unacceptable or defective bottles (refer for example to U.S. Pat. Nos. 5,979,635 and 6,043,504). Once any unacceptable bottle has been detected, it must be removed from the line or stream. It will be appreciated that commercial reality means that the production line cannot be stopped or generally even slowed down each time an unacceptable bottle has to be removed. It is also important to note that although there is often a constant small space between adjacent bottles in the moving line such bottles might be, and often are, in contact. This clearly complicates the removal of each unacceptable bottle since it must be removed without affecting the speed or direction of movement of the two adjacent and acceptable bottles and the effect the latter bottles may have on bottles adjacent to them and so on. Moreover, although in some instances as the present, simple rejection to a rejection bin of unaccepted bottle may be all that is required, there are instances when it is desirable to direct rejected bottles to one of several possible locations and in a controllable manner; in essence, sort the bottles. For example, a bottle, which has been found to have lower than the prescribed amount of beer, (i.e. it is a “low-fill”) might be re-directed to a station which empties the bottle of beer and the beer and the bottle are reclaimed. In another case a bottle with the label missing could result in the rejected bottle being returned to the labeller. Alternatively, there may be a need to collect non-standard bottles.

Many commonly used rejection or sorting systems involve an actuator assembly which includes a piston carrying a bottle-contacting member or pad which assembly is located adjacent the side of the conveyor, the actuator member being arranged to extend across the conveyor at right angles to the direction of travel of the bottles and to be retracted along the same path. As it advances, the pad contacts the body of the moving bottle to be diverted with more or less force depending on a number of factors. The bottles are essentially struck out of the moving line of bottles hopefully leaving the adjacent, and especially the immediately following, bottle unaffected as regards its velocity and direction. The diverted bottles may be directed off the conveyor adjacent to a collection receptacle or redirected on to another conveyor adjacent the first conveyor; refer, for example, to U.S. Pat. No. 3,133,640. Systems of this type are called “boppers” or “bang-bang” systems because of their mode of action. U.S. Pat. No. 5,979,635 discloses a system of using a type of diverter assembly of the bopper-type as described above but with provision to extend the servo activator in a controlled pre-determined manner to a position adjacent to the article to be deflected where, preferably, it pauses prior to initiating the actual diversion of the article according to an ejection waveform. Such systems are quite complex and require significant maintenance.

It is an object of the present invention to provide a simple and inexpensive contact method and device for the detection and optional removal in a single action of non-standard bottles from a line of standard and non-standard bottles travelling in single file at speed on a conveyor.

### SUMMARY OF THE INVENTION

The present invention utilizes physical differences between standard and non-standard bottles to rapidly and efficiently via mechanical means detect and thereby subsequently handle, e.g. reject the non-standard bottles from a stream comprising both types of bottles. A bottle detection member is arranged to extend into the path of the line of the bottles and be maintained at a pre-determined height and lateral distance, which allows a standard bottle to pass undetected but for a non-standard bottle to be detected by contacting the member and then following identification, be subjected to a second action such as rejection or sorting. In one embodiment, the detection member may be a simple panel, strip or bar of material, a metal such as, for example, steel or a plastics material such as polyamide plastic, is arranged to extend over a single file conveyor transporting a stream of bottles. The extent of overlie and the vertical location thereof is very important and is determined by the physical difference between the standard bottle and the non-standard bottles to be detected. For example, if the shoulder of the standard bottles is lower than that of the non-standard, then the bar can be arranged to be located over the conveyor track a lateral distance and at a height which allows the shoulders of the standard bottle to pass under—and that bottle proceed along the conveyor undetected or unhindered—whilst the shoulder of the non-standard bottles strikes the detection bar and the bottle is detected. There may be more than one detection member, for example, one may be positioned to contact a non-standard bottle having a larger diameter neck than the standard bottle and a second can be positioned at the same or another station to contact a non-standard bottle which has a higher shoulder than the standard bottles.

Although the detection member may preferably contact the bottles at any position intermediate the height of the standard bottle in the stream, for practical reasons, preferably the bar is positioned to be contact by the bottle above the height of the wall of the conveyor along which the bottles are traveling since the device is usually located adjacent the conveyor and changing the interior wall of the sidewall along which the bottles are traveling and may contact is not preferred. In any event, the deflection of the detection member is itself detected by appropriate sensing means.

Various sensors can be used to detect deflection by rotation, bending or other movement of the detection member. For example, a mechanical sensor such as a simple micro switch. This is a mechanical device that contains two internal contacts. Microswitches are modular, inexpensive to produce, dust and contaminant resistant and “metered”. By “metered” is meant that it clicks at the same point when the actuator is depressed. The consistency is maintained not only for the lifetime of the switch but for other microswitches of the same model. They are therefore easily maintained and replaced. Such devices may be obtained from many manufacturers including Honeywell Inc at 11 West Spring Street, Freeport, Ill. 61032. Photoelectric switches may also be used as sensors, a major advantage of the photoelectric switch being that it detects, but does not contact the moving detection member. More information regarding photoelectric devices can be found at the website www.theproductfinder.com/sensors.phosen.htd which site also includes a list of manufacturers or suppliers of the devices. In any event, it is preferred that a through beam rather than a reflective sensor is used since it would possibly be more effective in view of the adverse conditions in facilities where devices of the present invention are used, such as dust or dirt.

The device of the present invention may be located at any position in the process where there is a single-file conveyor section and bottles travel close or adjacent to one wall thereof. For example, a section where there is already in place, a bottle ejection or rejection system, e.g. at the filler or after the labeller. One preferred location is prior to the washer not only because non-standard bottles can cause shutdown of the washer but this eliminates the bottle prior to their being processed and thus incurring unnecessary continuing processing costs.

It might be noted that a non-standard bottle—if any—which falls totally within the profile of the standard bottle will not be detected by the present system but would probably be readily and visibly discernable and be removed well prior to it being included in the float.

In one aspect the present invention provides a device for detecting non-standard bottles in a stream comprising standard and non-standard bottles traveling on a conveyor along a path through a station comprising a bottle detection member at said station and extending into said path and adapted to be contacted and deflected from a base position only by a traveling non-standard bottle and, following passage of said station, return to said base position, and sensing means adapted to detect a deflection movement of said member and then generate a detection signal.

Preferably, the detection member is adapted to contact said bottle intermediate the height of the bottle.

It is preferred that the laterally outer most-edge i.e. the edge overlying the conveyor track is shaped to conform to at least part, especially the shoulder and/or neck part, of a standard bottle.

A single detection device, by incorporating two separate detection members each provided with associated sensor means and circuitry can be used to detect two different non-standard bottles.

In a further embodiment, two or more detection devices can be installed on the same conveyor track, one downstream of the other, on the same or different sides.

In either case, the created signal may be provided to a single diverter device such as a bottle ejector or two or more such devices, downstream of said detectors to allow sorting of the bottles.

In a further embodiment, the present invention provides a novel detection device as described above in combination with bottle diverter to form a rejection or sorting device and system.

In a further embodiment, the invention provides a system for treating returnable and reusable standard beverage bottles and re-filling same with a beverage, which bottles are transported to the various activity stations in a single file wherein standard bottles are returned for use in combination with a number of non-standard bottles are returned for reuse, the latter being required to be separated out, the improvement comprising detecting and ejecting or removing foreign bottles as described above and processing said standard bottles to a beverage filled condition.

### DESCRIPTION OF THE DRAWINGS

The present inventions will be further described but not limited by reference to the accompanying drawings in which:

FIG. 1 is a side elevation of three different bottles which may be included in a bottle float.

FIG. 2 is a plan diagrammatic view of a conveyor carrying a number of bottles in single file to and through a device of the present invention.

FIG. 3 is an angle perspective from above of a standard bottle approaching a detection device of the present invention; and

FIG. 4 is a cross-section viewed from above in the direction of the line 3-3 in FIG. 3.

FIG. 5 is a similar view to the upper part of FIG. 3 with a non-standard bottle approaching the detection member.

FIG. 6 is a similar view to that shown in FIG. 1 but wherein two bottle detection devices are shown adjacent the same conveyor sidewall.

FIG. 7 is an angle perspective from above of a standard bottle approaching another embodiment of the device of the present invention.

FIG. 8 is an angled perspective from above of a standard bottle approaching another embodiment of the device of the present invention; and

FIG. 9 is a diagrammatic plan view of the specific action of the detector panel of the device of FIG. 8.

In the following, like numbers indicate similar parts in the various drawings and a single arrow indicates direction of travel.

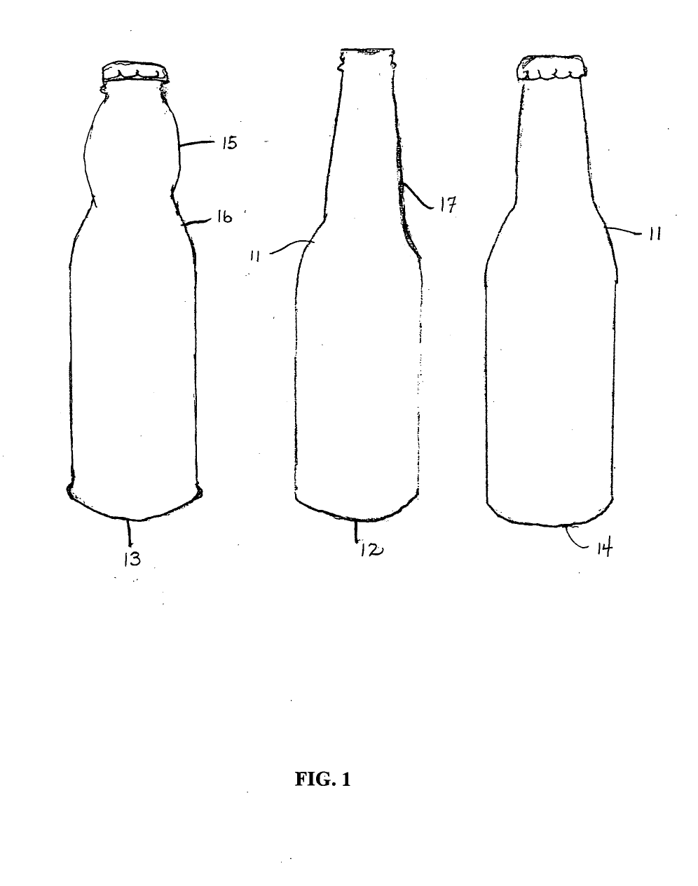

Turning to the drawings, FIG. 1 shows three bottles of similar volume, approximately 350 mL. The centre bottle 12 is the present “industry bottle” in Canada, that is the one used on most of their products by all the major brewers in Canada. Bottle 13 may for example be a beer bottle imported from Japan and beer bottle 14 is a bottle imported from Germany. Although generally similar, there are clear differences. Refer for example to the shoulders, both location and shape; the shape and length of the necks; and the bottle heights, bottle 12 being slightly taller than 13 or 14. The present invention utilizes these differences in fulfilling its objective, that is to detect by contact non-standard bottles in a stream of standard and non-standard bottles.

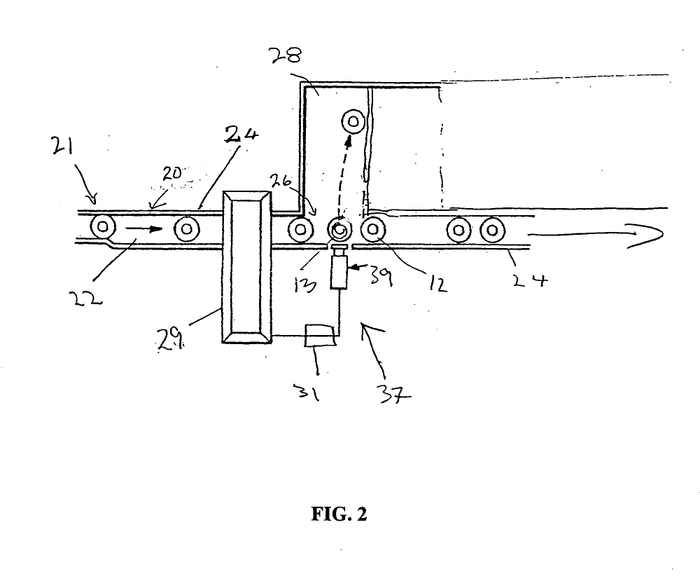

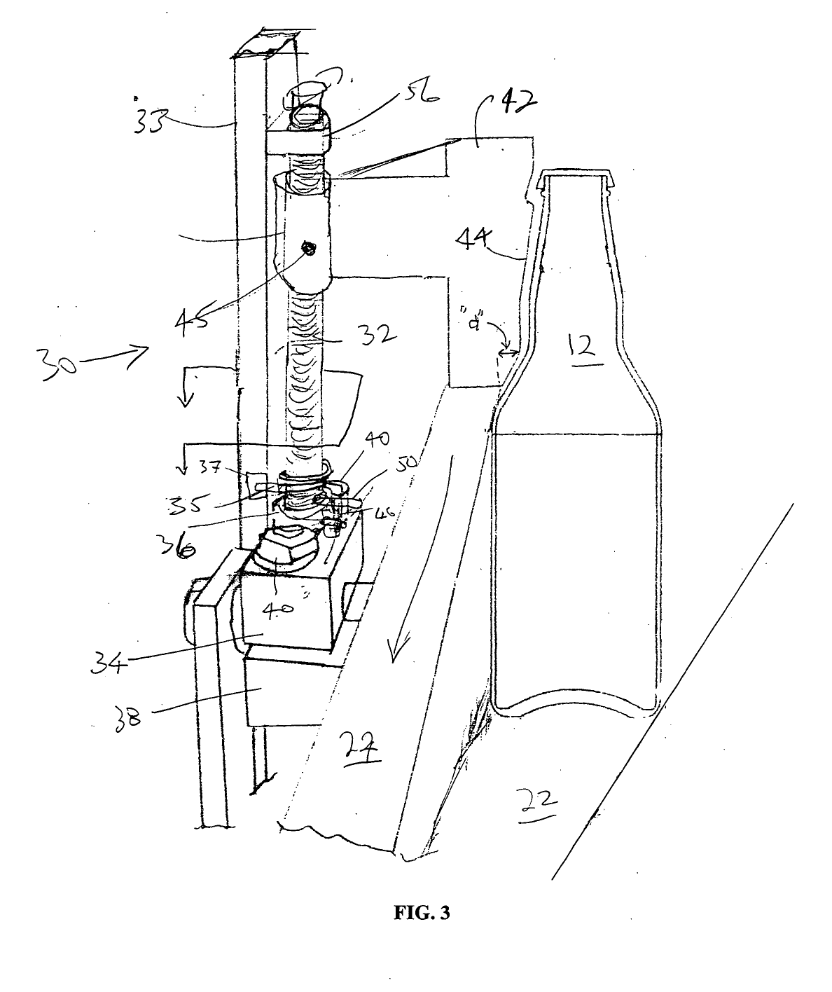

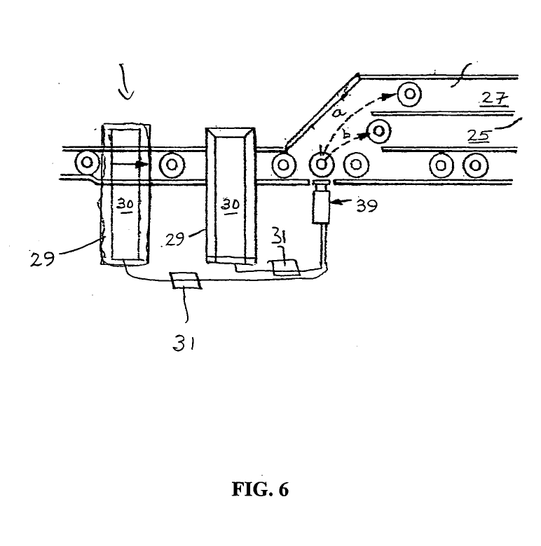

Turing to FIGS. 2 and 3, those show a conveyor, generally designated 20, having a track 22 upon which a single file stream 21 of standard bottles 12 and the occasional non-standard bottle 13 are travelling. Adjacent track 22 are conveyor sidewalls 24. It should be noted that sidewalls 24 are laterally spaced apart only slightly more than the width of track 22 and the diameter of the bottles 12 and 13, although the diameter of those, as between different bottles, can and does vary, usually only by a little. Part of one of the sidewalls 24 has been removed to form an opening 26 which provides access to a bottle rejection bin 28. The bin 28 may be replaced by an opening to a bottle collecting table or a conveyor e.g. 25 and 27 in FIG. 6, leading to such a bin or another collection table (not shown). Located adjacent to sidewall 24 is a bottle detection device generally designated 30 of the present invention represented by box 29 and rejection circuitry 31. Turning to FIG. 3, the detection device, generally designated 30, comprises a vertically oriented axel rod 32 located adjacent to sidewall 24 and maintained vertically in position by being journaled into block 34 via bearing nut 36 and retained by collar 56 near its upper end. Block 34 itself is maintained firmly in position by being secured to conveyor frame member 38 by bolts 40. Located on axel 32 is bottle detection member/panel 42, an edge 44 of which is shaped or profiled to conform to the shape of the upper part of the standard bottle 12. It is located so that the bottle 12 does not make contact therewith but is adapted to be contacted by non-standard bottles such as 13, as described in more detail with respect to FIG. 5. This panel 42 is maintained at the desired height above the conveyor track 24 by two locking grub screw 45. The desired height above the conveyor 24 a short pre-determined distance “d” is very important to the operation of the present invention: its determination is explained in more detail herein. As shown, the edge 44 is profiled to allow passage of a standard bottle—refer FIG. 3—but not a non-standard bottle which has a neck 15 having a larger diameter than that of a standard bottle—refer FIG. 5.

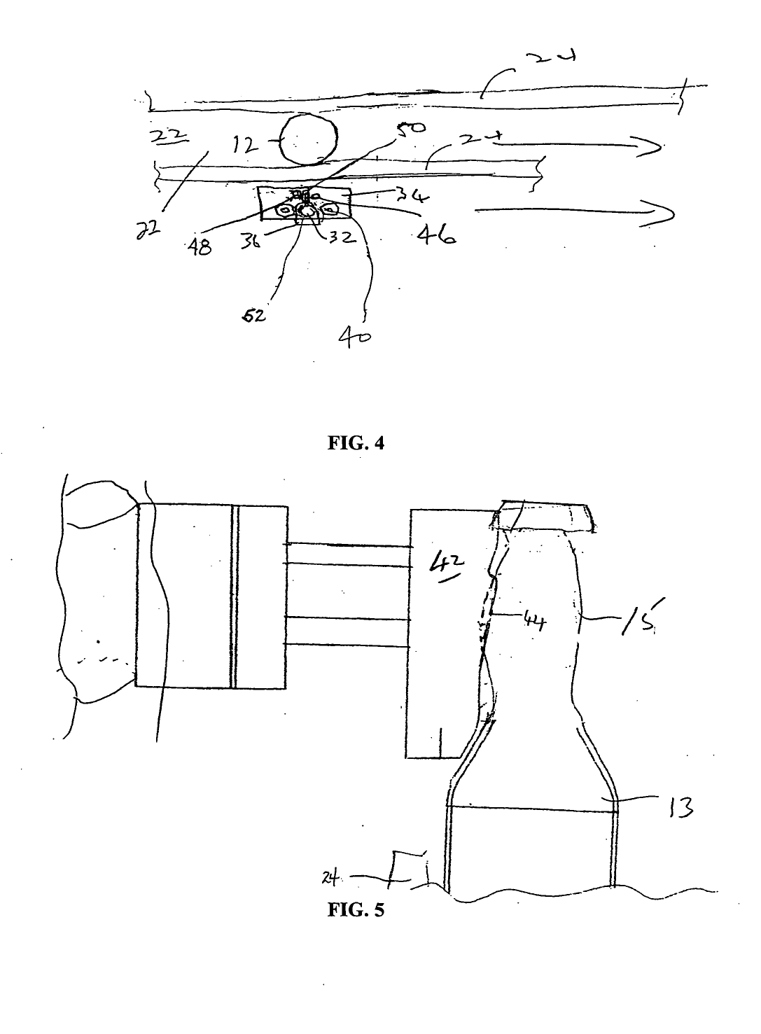

Turning to FIG. 4, this is a plan view taken along the line 3-3 in FIG. 3 and shows in details the top of block 34 and journal bearing 36 in which is located rotatable rod 32. Also shown are bolts 40 and conveyor sidewalls 24 and standard bottled 12. It may be noted that the diameter of the main body of most bottles is very similar and hence the width of conveyor 24 can readily accommodate all the bottles in a close manner, that is along with any bias toward sidewall 24 deemed necessary, all the bottles travel immediately adjacent the inner surface of sidewall 24. Bias of bottles can be affected by adjustment of the conveyor track 22 as is well known in the art. Finally, located adjacent rotatable rod 32 is microswitch contact or actuator 46, which extend vertically from the top surface of block 34, and backstop 48 which also extends vertically from block 34. Located between actuator 46 and back stop 48 is rod 50 which is rigidly affixed to, and carried by rod 32 and rotates with rod 32. Finally, spacing member 35 (omitted in FIG. 4 for clarity)—refer FIG. 3, is anchored on rod support 33 at 37 and secured to rod 32. Spring 52 is adapted to allow panel 42 to rotate relatively easily but to urge the panel 42 rapidly back to the panel's base condition as soon as the panel is no longer in contact with a passing non-standard bottle. In the neutral, i.e. unbiased, position, rod 50 is located between actuator 46 and backstop 48 and extends at right angles to the sidewall 24. Upon rod 50 rotating in a clockwise manner in response to detection panel 42 being urged in the direction of conveyor 20 travel by a non-standard bottle 13 traveling on the conveyor, rod 50 also rotates in a clockwise manner thereby contacting the actuator 46 of the microswitch (not shown). Upon continued travel of the bottle 13 passed the detector 42, the latter is urged by the spring 55 in an anticlockwise manner back to its neutral position. Any tendency of the contact rod 50 to rotate past the neutral position is precluded by backstop 48.

FIG. 5 illustrates the situation just prior to detection by contact of a panel 42 by a non-standard bottle. Specifically, in FIG. 5 a non-standard bottle 13 adjacent sidewall 24 is just arriving at detection panel 42 which has not yet contacted the bottle. The panel 42 is arranged to extend over the conveyor track 24 i.e. into the path of travel of the bottles sufficient to contact a pre-selected part—in this case the neck 15—of a non-standard bottle 13—but insufficient to contact any part of a standard bottle 12 which has a profile equivalent to edge 44. A part of neck 15—shown in phantom—of traveling non-standard bottle 13 contacts detection panel 42 at high speed and the panel is rotated clockwise causing rod 32 to rotate a similar amount and thence have contact rod 50 make contact with and trigger actuator 46 of the micro-switch. The latter introduces a signal to obtain rejection of the non-standard bottle 13. This rejection is delayed via circuitry 31. This rejection is delayed for an usually short, period of time so that the bottle 13 can move through and exit the detection station and reach a reject station 37 containing a standard rejecter or bottle diverter device 39 prior to activation thereof. That delay may be provided for example by a tracking system many of which are commercially available. One such system is a shift register system such as the “Checkmate” software system of Krones Inc., 9600 South 58^{th} Street, Franklin Wis. 53132-0100. The rejection device 39 may be one of the many “bopper” systems, slat rejecters or the like. The rejected bottles are transferred onto a rejection table or into rejection bin 28. It will be appreciated that a relatively tall, thin object such as a bottle when traveling at speed is generally in a relatively unstable equilibrium condition and upon receiving a sharp blow may immediately respond by toppling over sideways. Since it is travelling rapidly longitudinally along the conveyor it will generally actually exit the line of bottles 21 and conveyor track 24 at an acute angle to the direction of travel of the bottles. Since a used non-standard bottle 13 is generally not a commercially viable item in this situation and merely goes to be recycled as glass, this rejection treatment, which might result in breakage of the bottle, is totally acceptable.

However if it is desired to collect the rejected bottles in a good condition, the rejecter is preferably one that can handle the bottles in a more controlled and consistent manner. Such a device is claimed in Assignee's pending U.S. patent application Serial. No. 09/891,616 (Frederick Linton) the contents of which application are incorporated herein in its totality and the combination of the herein described mechanical detector and a container rejecter device constitutes another aspect of the patent invention.

To summarize the operation, the non-standard bottle 13 has a neck 15 of greater diameter than that of standard bottle 12 and the neck does not match the profiled edge 44 resulting in panel 42 being contacted by and rotating clockwise under the influence of bottle 13 as it passes through the detection station. The rotation results in contact 50 activating the microswitch contact 46 which results in a signal passing to rejection circuit 31. In its turn, and following a short delay, a signal is sent to activate rejection device 39 which responds by urging the then arrived detected bottle 13 out of line 21 and into reject bin 28. In the meanwhile, detection panel 42, following passage of the non-standard bottle 13, reverses under the influence of spring 50 and returns rapidly to it neutral position to resume its detection function. Any tendency to go past the neutral position is precluded by backstop 48. The result is rapid return to the pre-use neutral location to enable accurate detection of the physical differences been standard and non-standard bottles to be repeated rapidly and repeatedly at speed.

Turning to the system shown in FIG. 6 this allows for the sorting of two different non-standard bottles from a line comprising those and standard bottles. In this case, two ejection devices 29 are located in a longitudinally spaced manner adjacent wall 24 of conveyor 22. The detector panel 42 in each of the detection stations 30 is profiled to detect a different physical characteristic of the expected different design non-standard bottles. For example, one panel could be shaped to detect a shoulder and the second a neck of a non-standard bottle, both characteristics being chosen because they are physically detectably different from corresponding features of a standard bottle 12. When a specific detection device makes a detection, a signal is sent—with the appropriate delay—to the associated rejection device 39. In this system, a controlled rejection device, such as that the subject of U.S. patent application Ser. No. 09/091,616 is used and arranged to urge the two types of rejected non-standard bottles 13 out of bottle stream 21 but along different paths such as “a” and “b” in FIG. 6. The result is that that line 21 of bottles is sorted into three streams of bottles, one of standard bottles 12 and two of different non-standard bottles 13, traveling on three adjacent conveyors 22, the main conveyor 25 and 27.

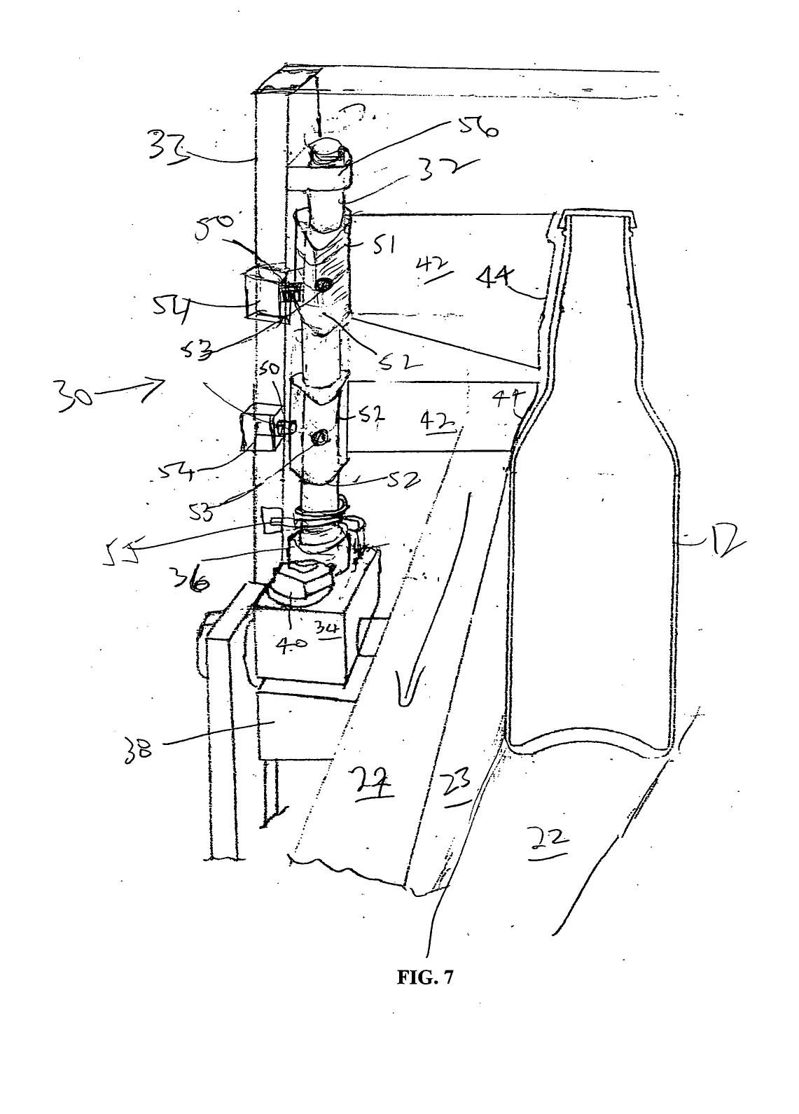

Turning to FIG. 7, this shows a single detection device 30 which is adapted to detect two different non-standard bottles. It is provided with two detection panels 42, an upper and a lower one, both rigidly affixed to rotable axel 32 via collars 51 and grub screws 53. Each collar 51 has a “pear” shape providing a cam surface 53 on its downstream side. Adjacent each cam surface 52 is a microswitch 54 having an activator 50. Individual backstop members (48 not shown in this FIG.) are located on the upstream surface of support 33 and this prevents unwanted counterclockwise movement of upper and lower panels 44. Upper detector panel 44 is profiled to match the profile of the shoulder 18 of bottle 12. The bottle 12, and indeed, all the bottles in line 21 proceed along track 22 effectively immediately adjacent the inside surface 23 sidewall 24. The distance “d” the panels extend past sidewall 24 and overlap track 22 is chosen to ensure that any standard bottle 12, because its profile matches that of the panel or panels 42 does not contact those panels, which bottles are therefore not contacted nor deflected. However, the opposite is true with respect to any non-standard bottle 13 which contacts a panel 42 resulting in the creation and sending of a detection signal.

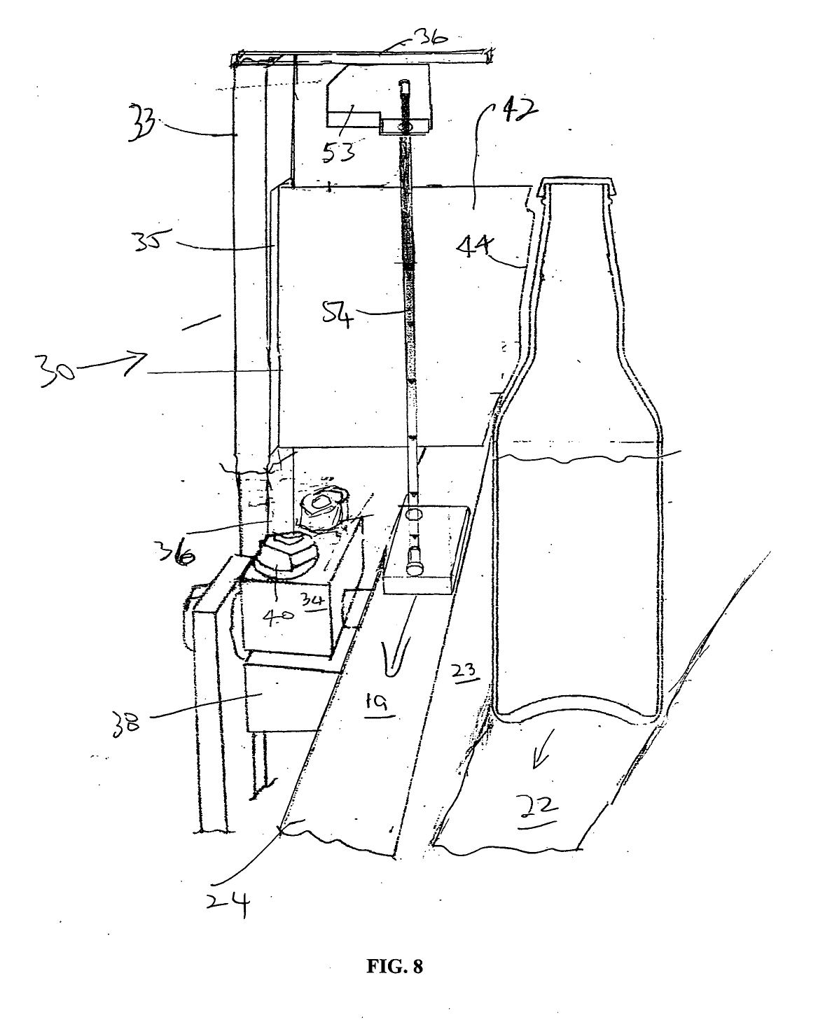

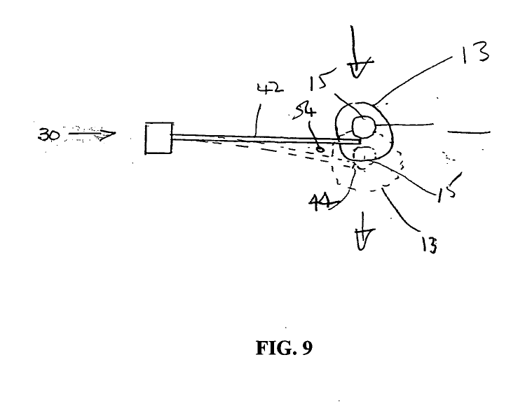

Turing to FIG. 8, the detector member 42 is of similar edge profile 44 to that shown is FIG. 3 but is made of a resilient plastics material such as polypropylene. It is rigidly secured to support 33 via flange 35. Located above sidewall 24 on support arm 36 is the emitter 53 of a photoelectric device, the corresponding receptor 54 of that device being located on the top surface sidewall 24. The emitter and receptor are aligned to allow for the vertically emitted beam 54 to enter the receptor as shown. This is the base condition of the system. Also shown is the location of beam 54 passing from emitter 53 to receptor 54. In the normal or base condition, the beam 54 is in place and no detection signal is generated nor sent. Upon panel 42 being deflected by non-standard bottle as discussed above with respect to FIG. 9 the beam 54 is broken and this initiates the creation and sending of a detection signal to associated circuitry 31 and on to a deflector device 39 (not shown) as explained above with respect to the embodiment show in FIGS. 2 and 6.

FIG. 9 is a plan diagrammatic representation of the device of FIG. 8 showing a non-standard bottle 13 having a neck 15 of larger diameter than that of a standard bottle 12 just upstream of panel 44. Shown in phantom, is the situation wherein the bottle 13 has moved into and is about to leave the detection station. The panel 42 is shown having been deflected clockwise thereby forming an arc and it is held there since the bottle neck 15 has not yet passed the deflected edge 44 of panel 42. Following passage, the panel will, because of its resiliency, immediately return to its base position as shown in bold. A backstop (not shown) may be positioned if required.

In operation in a beer bottle recycle and reuse system, bottles are returned, usually in the cartons they were contained in when originally purchased full, to a retail store or other collection centre from where they are returned to the brewing facility for reuse. Usually they are stacked on pallets, containing about 90 cartons each containing 24-341 mL/12 oz “pint” bottles per carton. Commercially available equipment depalletizes the cartons, removes the bottles therefrom to form a float which supplies a conveyor which transports the bottles to a washing system. Following washing, they are transported again by conveyor systems to a filling station, then a pasteurization station and finally to packaging. In a number of these stations, a non-standard bottle causes serious problems leading in many instances to line shutdown. Obviously, it is preferable that the non-standard bottles be removed at the earliest stage of the recycle process and this is following being removed from the cartons in which they had been returned. Bottles having an obviously very different design etc. are readily noted and removed, especially those with neck and body diameters or heights markedly different to similar characteristics of the chosen standard bottle.

Operation

It is believed that the operation of the device and the system of the present invention is evident from the above but a brief summary is as follows.

A stream 21 of bottles, the major proportion of which are standard bottles 12 and some non-standard bottles such as 13 or 14, traveling at high speed approach one—FIG. 2—or more than one—FIG. 6—detection stations 29. The track is adapted to ensure the bottles travel adjacent and close to the sidewall 24 to the side of which the detection device is located. The detection device 30 at each station generally has one detection member 44—FIG. 3 or 8—the edge 44 closest to the stream 21 having a shape or profile matching that of part of standard bottle. The panel 44 overlies track 24 but not sufficiently to contact a standard bottle 12 passing therealong. However, a non-standard bottle 13—refer FIG. 5 and FIG. 9—having a physical characteristic—in this case, a wider diameter neck—different to a standard bottle, cannot pass without contacting and deflecting panel 44. The inventive device and system are designed to ensure that contact is insufficient to deflect or eject the bottle but does deflect or move panel 44 either by causing rotation of same FIGS. 3 and 5 embodiment—or by bending same—FIGS. 8 and 9 embodiment. It will be appreciated that the amount of deflection is relatively small and the time taken to deflect and return to the base position is also very small.

In both cases, the deflection of panel 44 triggers an associated microswitch or photosensor which via circuitry means 31, initiates a delay calculated to allow the detected bottle to travel to a bottle diverter 39. The bottle is then ejected or otherwise transferred to a bin 28 or another conveyor 25 or 27. In either case, panel 44, following passage of bottle 13 immediately returned to its base or neutral position effectively immediately to be available to repeat its function.

Variations of the basic device can be used to sort bottles, refer to FIG. 7 which shows one device which can sort two types of non-standard bottles or FIG. 6 where two single devices can be used in series to effect sorting. In this capacity, if it is desired to collect the rejected bottles intact, it is preferred that the diverter device, or devices if used, be of a controlled or bottle urging type as described above to reduce any tendency for the bottle to tip over, contact other rejected bottles and break etc.

The present invention therefore presents a simple system for detecting and handling undesirable non-standard bottles contained in a float of standard and required bottles. The detection is effected in a simple mechanical manner at low cost with components which are inexpensive, hardy, require little maintenance and take up little space in the facility. Moreover, the device and system are readily adjusted to accommodate a change in non-standard bottles to be handled. Obviously, the device and system can be sued to advantage to handle articles similar to the bottles as described above.

1. A device for detecting non-standard bottles in a stream comprising standard and non-standard bottles traveling on a conveyor along a path through a station, comprising a bottle detection member at said station extending into said path and adapted to be physically contacted and deflected from a base position only by a traveling non-standard bottle and, following passage of said non-standard bottle through said station, return to said base position, and sensing means adapted to detect a deflection of said member and then generate a detection signal.

2. A claim according to claim 1 wherein said detection member is adapted to contact said bottle intermediate the height of the bottle.

3. A device according to claim 1 wherein said detection member is a lever and when contacted by said traveling bottle rotates to activate said sensing means.

4. A device according to claim 1 wherein said detection member is flexible and adapted to bend to activate said sensing means when contacted by said traveling bottle.

5. A device according to claim 2 or 3 wherein the sensing means is a photoelectric device.

6. A device according to claim 3 wherein said sensing means is a microswitch.

7. A device according to claim 2 wherein a laterally outermost edge of said detection member is shaped to conform to a profile of at least part of a standard bottle.

8. A device according to claim 7 wherein said profile is of the neck and/or shoulder of said standard bottle and the detection member is located in said stream at a position such that any standard bottle in said stream is adapted to pass closely adjacent said profile member without contacting said member.

9. A device according to claim 1 wherein said station contains two such detection devices, the detection member of each being adapted to contact a different type of non-standard bottle and the sensing means associated with each detection member is adapted to provide a different detection signal.

10. A device according to claim 9 wherein both detection signals are introduced to a same bottle rejection device which is adapted to propel the associated bottle to be rejected off the conveyor and into different bottle receiving locations located adjacent said first conveyor.

11. A detection device according to claim 1 in combination with a bottle diverter device, which adapted to be activated by said detection signal from said detection device.

12. A device according to claim 11 wherein the detection a bottle diverter is located adjacent a conveyor downstream of said detection device and is adapted to divert to a non-standard bottle associated with said detection signal from said detector device.

13. In a system for treating returnable and reusable standard beverage bottles and refilling same with a beverage, which bottles are transported to various activities in a single file and wherein standard bottles are returned for use in combination with a number of non-standard bottles which are required to be separated out, the improvement comprising passing a stream comprising both standard and non-standard bottles traveling in single file along a conveyor to a device comprising a station which includes conveyor means to transport said bottles to and through said station and a detection device as claimed in claim 1.
